(19) United States
(12) Patent Application Publication
(10) Pub. No.: US 2023/0397603 A1
(43) Pub. Date: Dec. 14, 2023

(54) FERTILIZER COMPATIBLE AGROCHEMICAL SUSPENSIONS

(71) Applicant: BASF SE, Ludwigshafen (DE)

(72) Inventors: Wen Xu, Research Triangle Park, NC (US); Kara Walden, Benton, NC (US)

(21) Appl. No.: 18/033,842

(22) PCT Filed: Oct. 25, 2021
(86) PCT No.: PCT/EP2021/079443

§ 371 Date: Apr. 26, 2023

Related U.S. Application Data
(60) Provisional application No. 63/180,258, filed on Apr. 27, 2021.

(30) Foreign Application Priority Data
Nov. 3, 2020 (EP) 20205340.1

(51) Int. Cl. A01N 25/22; C05G 3/60; A01N 25/04; C05G 5/27

(52) U.S. Cl. CPC A01N 25/22; C05G 3/60; A01N 25/04; C05G 5/27

(57) ABSTRACT

The invention relates to an agrochemical suspension comprising a) an agrochemical active, wherein the agrochemical active is present in the form of suspended particles in the agrochemical suspension, b) a polymer P being a homo- or copolymer of (meth)acrylic acid with a mass average molar mass M_{w} of at least 100,000 Da; c) a thickener; and d) naphthalenesulfonate formaldehyde condensate, wherein the concentration of the naphthalenesulfonate formaldehyde condensate is from 0.2 to 0.9 wt % based on the total weight of the composition. It also relates to a tank mix comprising the agrochemical suspension and an inorganic fertilizer; to a method for preparing the tank mix; and to a method of controlling phytopathogenic fungi and/or undesired plant growth and/or undesired insect or mite attack and/or for regulating the growth of plants including application of the agrochemical suspension.

The invention relates to an agrochemical suspension comprising an agrochemical active; a polymer P being a homo- or copolymer of (meth)acrylic acid with a mass average molar mass M_{w} of at least 100,000 Da; a thickener; and naphthalenesulfonate formaldehyde condensate, wherein the concentration of the naphthalenesulfonate formaldehyde condensate is from 0.2 to 0.9 wt % based on the total weight of the composition. It also relates to a tank mix comprising the agrochemical suspension and an inorganic fertilizer. Further objects are a method for preparing a tank mix comprising the step of contacting an inorganic fertilizer with the agrochemical suspension; and to a method of controlling phytopathogenic fungi and/or undesired plant growth and/or undesired insect or mite attack and/or for regulating the growth of plants, wherein the agrochemical suspension or the tank mix is allowed to act on the respective pests, their environment or the crop plants to be protected from the respective pest, on the soil and/or on undesired plants and/or on the crop plants and/or on their environment.

WO2019072602A1 discloses agrochemical compositions comprising a pesticide and a homo- or copolymer of (meth)acrylate with a molecular weight of at least 100,000 Da. The agrochemical suspensions display a high degree of storage stability and high compatibility with liquid fertilizer compositions.

It was found that there is still room for improving the physical stability of the suspensions as disclosed in WO2019072602A1, especially reducing gelling at elevated temperatures or upon temperature variations in temperature cycling programs. It was another objective to further improve the compatibility of the suspension with fertilizers, and high salt concentrations in general, which conditions may be present in tank mix compositions of the agrochemical composition with fertilizers. Accordingly, it was an objective of the invention to increase the physical stability of resulting tank mixes, especially reduce gelling tendencies of high-salt compositions comprising the agrochemical suspensions.

The objective has been achieved by an agrochemical suspension comprising
a) an agrochemical active,
b) a polymer P being a homo- or copolymer of (meth)acrylic acid with a mass average molar mass M_{w} of at least 100,000 Da;
c) a thickener; and
d) naphthalenesulfonate formaldehyde condensate,
   wherein the concentration of the naphthalenesulfonate formaldehyde condensate is from 0.2 to 0.9 wt % based on the total weight of the composition.

The agrochemical suspension contains at least a portion of the agrochemical active as solid particles suspended in a continuous phase, which is preferably an aqueous continuous phase. Accordingly, the agrochemical suspension is preferably an aqueous agrochemical suspension containing at least 5 wt % of water, preferably at least 10 wt %, more preferably at least 15 wt %, most preferably at least 20 wt %, especially preferably at least 25 wt %, such as at least 30 wt %, in particular at least 40 wt %, each time based on the total weight of the suspension. The agrochemical composition may contain up to 95 wt % of water, preferably up to 80 wt %, more preferably up to 70 wt %, most preferably up to 60 wt % of water, such as up to 50 wt % of water, each time based on the total weight of the suspension.

The agrochemical active is typically hardly soluble in water. The agrochemical active may have a water-solubility at 20° C. and pH 7 of up to 10 g/l, preferably up to 1 g/l, more preferably up to 0.5 g/l, and most preferably up to 0.1 g/l.

The agrochemical formulation contains an agrochemical active. The term “agrochemical active” refers to a substance that confers a desirable biological activity to the agrochemical formulation. Typically, the agrochemical active is a pesticide. Agrochemical actives may be selected from fungicides, insecticides, nematicides, herbicides, safeners, nitrification inhibitors, urease inhibitors, plant growth regulators, micronutrients, biopesticides and/or growth regulators. In one embodiment, the agrochemical active is an insecticide. In another embodiment, the agrochemical active is a fungicide, preferably metyltetraprole. In yet another embodiment the agrochemical active is a herbicide, preferably saflufenacil. In yet another embodiment, the agrochemical active is trifludimoxazin. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridinium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators. Suitable micronutrients are compounds comprising boron, zinc, iron, copper, manganese, chlorine, and molybdenum. Suitable nitrification inhibitors are linoleic acid, alpha-linolenic acid, methyl pcoumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or Nserve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolylmethyl)acetamides such as N-((3(5)-methyl-1H-pyrazole-1-yl)methyl)acetamide, and N-(1 Hpyrazolyl-methyl)formamides such as N-((3(5)-methyl-1H-pyrazole-1-yl)methyl formamide, N-(4-chloro-3(5)-methyl-pyrazole-1-ylmethyl)-formamide, N-(3(5),4-dimethyl-pyrazole-1-ylmethyl)formamide, neem, products based on ingredients of neem, cyan amide, melamine, zeolite powder, catechol, benzoquinone, sodium tetraborate, zinc sulfate, 2-(3,4-dimethyl-1H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl)guanidine, 1-((2-cyanoguanidino)methyl)urea; 2-cyano-1-((2-cyanoguanidino)methyl)guanidine; 3,4-dimethyl pyrazole phosphate; allylthiourea, and chlorate salts. Examples of envisaged urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants. In one embodiment, the agrochemical active is an insecticide. In another embodiment, the agrochemical active is a nematicide. In another embodiment, the agrochemical active is a compound of formula (I-A)

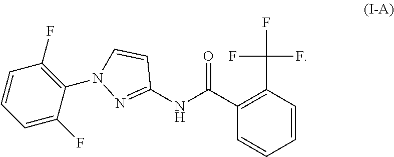 [SMILES: O=C(Nc1ccn(-c2c(F)cccc2F)n1)c1ccccc1C(F)(F)F]

Compound of formula (I-A) is may be identified by the name N-[1-(2,6-difluorophenyl)pyrazol-3-yl]-2-(trifluoromethyl)benzamide. Compound of formula (I-A) may be prepared as described in WO2018033467A1, experimental section.

The agrochemical active is present in the form of suspended particles in the agrochemical suspension. The particles may be characterized by their size distribution, which can be determined by dynamic light scattering techniques. Suitable dynamic light scattering measurement units are inter alia produced under the trade name Malvern Mastersizer 3000. The particles may be characterized by their median diameter, which is usually abbreviated as ×50 value. The ×50 value refers to a particular particle diameter, wherein half of the particle population by volume is smaller than this diameter. The ×50 value is typically determined according to ISO 13320:2009.

The particles may have an ×50 value of from 0.05 μm to 30 μm, preferably from 0.1 μm to 20 μm, more preferably from 0.5 to 20 μm, most preferably from 0.5 μm to 15 μm, especially preferably from 0.5 μm to 10 μm. The particles typically have an ×50 value of at least 0.75 μm, preferably at least 1 μm.

The suspended particles may be present in the form of crystalline or amorphous particles which are solid at 20° C.

Typically, at least 50 wt % of the agrochemical active may be present as solid particles based on the total weight of the agrochemical active in the agrochemical suspension, preferably at least 70 wt %, more preferably at least 90 wt %.

The agrochemical suspension may contain a further active ingredient, which may be selected from fungicides, insecticides, nematicides, herbicides, safeners, micronutrients, biopesticides, nitrification inhibitors, urease inhibitors, and/or growth regulators. The further active ingredient may be present in dissolved form or as suspended particles in the agrochemical suspension. The concentration of the further active ingredient is typically from 1 to 50 wt %, preferably from 10 to 25 wt % based on the total weight of the agrochemical suspension.

The agrochemical suspension further contains a polymer P. Such polymers have been described in WO2019072602A1, which is herein incorporated by reference in its entirety. Polymers P are commercially available under the trade names Sokalan PA 100 S or Sokalan PA 80 S from BASF.

The polymer P is characterized by its mass average molar mass (M_{w}), which may be experimentally determined by gel permeation chromatography. To this end, a hydrophilic vinylpolymer network column with a diameter of 7.8 mm and a length of 30 cm of the type TSKgel G3000PWXL may be used. The column temperature is typically chosen to be 35° C., and a flow rate of 0.5 ml/min may be applied. The detector may be a differential refractometer (DRI) detector of the type DRI Agilent 1100. A typical solvent is 0.01 mol/I phosphate buffered (=10 Na₂HPO₄+1.8 KH₂PO₄+2.7 KCl+137 NaCl in mmol/L) pH=7.4 distilled water with 0.01 M NaN₃. The calibration can be achieved with narrow molecular weight sodium salt polyacrylic acids homopolymers. Extrapolation may then be used to estimate the molecular weight distribution outside the range of these calibration standards with respect to the exclusion and permeation limits.

Polymers P are homo- or copolymers of (meth)acrylic acid. “(meth)acrylic acid” means acrylic acid and/or methacrylic acid. When reference is made herein to (meth)acrylic acid or other carboxylic acids as monomeric units in polymers, this shall be understood to mean the carboxylic acid per se as well salts of such carboxylic acid with organic and inorganic cations.

Polymer P have a mass average molar mass of at least 100,000 Da, preferably at least 150,000 Da, more preferably at least 200,000 Da, and in particular at least 230,000 Da. The polymer P may have a mass average molar mass of up to 10,000,000 Da, preferably up to 5,000,000 Da, more preferably up to 1,000,000 Da, and in particular up to 500,000 Da.

In one embodiment, polymer P is a homopolymer or a copolymer of methacrylic acid or its salts. In another embodiment, polymer P is a homopolymer or a copolymer of acrylic acid or its salts. In another embodiment, polymer P is a homopolymer of acrylic acid or its salts. In another embodiment, polymer P is a copolymer of acrylic acid or its salts with other monomers M having ethylenically unsaturated double bonds. In another embodiment, polymer P is a homopolymer of (meth)acrylic acid or its salts.

The term “homopolymer” relates to a polymer containing only one species of monomers, such as acrylic acid or methacrylic acid. Accordingly, the term “copolymer” relates to a polymer containing at least two species of monomers, such as acrylic acid and vinyl alcohol.

The polymer chain of polymer P may be modified by reaction with a chain transfer reagent, such as a mercaptan. Typically, the polymer P is end-capped by reaction with mercaptoethanol.

Suitable monomers M include vinylaromatic monomers such as styrene and styrene derivatives, such as a-methylstyrene, vinyltoluene, ortho-, meta- and para-methylstyrene, ethylvinylbenzene, vinylnaphthalene, vinylxylene and the corresponding halogenated vinylaromatic monomers, vinylaromatic monomers which bear nitro, alkoxy, haloalkyl, carboalkoxy, carboxy, amino and alkylamino groups, a-olefins, such as ethene, propene, 1-butene, 1-pentene, 1-hexene, isobutene, long-chain (C10-C20)-alkyl-a-olefins, dienes such as butadiene and isoprene, vinyl alcohol esters such as vinyl acetate, vinyl halides such as vinyl chloride, vinyl bromide, vinyl fluoride, vinylidene chloride, vinylidene fluoride, vinylidene bromide, vinylnitrile, vinyl carboxylates, 1-vinylamides such as 1-vinylpyrrolidone, 1-vinylpiperidone, 1-vinylcaprolactam, N-vinylimidazole, C₁-C₂₄-alkylesters and monosubstituted and disubstituted and unsubstituted C₁- to C₂₄-alkylamides of monoethylenically unsaturated monomers such as acrylic acid, methacrylic acid, fumaric acid, maleic acid and itaconic acid, vinylsulfonic acid, anhydrides such as maleic anhydride, unsaturated aldehydes such as acrolein, unsaturated ethers such as 1,4-cyclohexanedimethanol divinyl ether, 1,4-cyclohexanedimethanol monovinyl ether, butanediol divinyl ether, butanediol monovinyl ether, cyclohexyl vinyl ether, diethylene glycol divinyl ether, ethylene glycol monovinyl ether, ethyl vinyl ether, methyl vinyl ether, n-butyl vinyl ether, octadecyl vinyl ether, triethylene glycol vinyl methyl ether, vinyl isobutyl ether, vinyl 2-ethylhexyl ether, vinyl propyl ether, vinyl isopropyl ether, vinyl dodecyl ether, vinyl tert.-butyl ether, hexandiol divinyl ether, hexandiol monovinyl ether, diethylene glycol monovinyl ether, diethylaminoethyl vinyl ether, polytetrahydrofuran-290 divinyl ether, tetraethylene glycol divinyl ether, triallylamine, ethylene glycol butyl vinyl ether, ethylene glycol divinyl ether, triethylene glycol divinyl ether, trimethylolpropane trivinyl ether, aminopropyl vinyl ether. Preferred further monomers are those having at least two olefinically unsaturated double bonds, such as triallylamine.

In each case when reference is made to an acid like a carboxylic acid or a sulfonic acid as a monomer, this shall also include their respective salts.

Preferred monomers M are fumaric acid, maleic acid, itaconic acid, vinylsulfonic acid, 2-acrylamido-2-methyl-1-propanesulfonic acid maleic anhydride, acrylamide, N-vinyl pyrrolidone.

In one preferred embodiment, polymer P is a homopolymer of acrylic acid with a mass average molar mass of at least 100,000 Da, more preferably at least 150,000 Da, even more preferably at least 200,000 Da.

Polymer P is usually synthesized in the usual manner by means of free-radical polymerization. However, it is also possible to employ other processes for the polymerization, for example controlled free-radical processes. The polymerization is carried out in the presence of the monomers and of one or more initiators and can be carried out with or without solvent, in emulsion or in suspension. The polymerization can be carried out as a batch reaction, as a semi-continuous operation or as a continuous operation. The reaction times are generally in the range of between 1 and 12 hours. The temperature range within which the reactions can be carried out is generally from 20 to 200° C., preferably from 40 to 120° C.

The initiators which are employed for the free-radical polymerization are customary free-radical-forming substances. The initiator is preferably selected from the group of the azo compounds, of the peroxide compounds or of the hydroperoxide compounds. Examples that may be stated include acetyl peroxide, benzoyl peroxide, lauroyl peroxide, tert.-butyl peroxyisobutyrate, caproyl peroxide, cumene hydroperoxide, azobisisobutyronitrile or 2,2-azobis(2-methylbutane)nitrile. Particularly preferred is azobisisobutyronitrile (AIBN).

The free-radical polymerization for making polymer P is preferably carried out in solution. Solvents are water, alcohols such as, for example, methanol, ethanol, propanol, dipolar-aprotic solvents such as, for example, DMF, DMSO or NMP, aromatic, aliphatic, halogenated or nonhalogenated hydrocarbons such as, for example, hexane, chlorobenzene, toluene or benzene. Preferred solvents are water, isopropanol, methanol, toluene, DMF, NMP, DMSO and hexane.

Polymer P is usually soluble in water, for example to at least 5 g/l at 20° C. (preferably to at least 20 g/l, in particular at least 50 g/l).

Agrochemical suspensions according to the invention usually comprise at least 0.1% by weight, preferably at least 0.5% by weight and in particular at least 1% by weight of polymer P. Compositions according to the invention usually comprise from 0.1 to 15% by weight, preferably from 0.1 to 10% by weight and in particular from 0.1 to 5% by weight of polymer P, each time based on the total weight of the suspension.

The weight ratio of the agrochemical active to polymer P can vary within any range, for example in the range of from 1:10 000 to 10 000:1, preferably in the range of from 1:1000 to 1000:1, especially preferably in the range of from 1:100 to 100:1, such as from 50:1 to 1:1.

The agrochemical suspension can in principle be prepared at any pH. Preferably, agrochemical compositions according to the invention have a pH below 9, more preferably from 4 to 8.

The agrochemical suspension contains a thickener. The term “thickener(s)” usually refers to inorganic clays (organically modified or unmodified), such as bentonites, attapulgite, hectorite and smectite clays, and silicates (e.g. colloidal hydrous magnesium silicate, colloidal hydrous aluminum silicate, colloidal hydrous aluminum magnesium silicate, hydrous amorphous silicon dioxide); and organic clays, such as polycarboxylates (e.g. poly(meth)acrylates and modified poly(meth)acrylates), polysaccharides (e.g. xanthan gum, agarose, rhamsan gum, pullulan, tragacanth gum, locust bean gum, guar gum, tara gum, Whelan cum, casein, dextrin, diutan gum, cellulose, ethylcellulose, hydroxyethylcellulose, methylhydroxypropylcellulose), polyvinyl ethers, polyvinyl pyrrolidone, polypropylene oxide—polyethylene oxide condensates, polyvinyl acetates, maleic anhydrides, polypropylene glycols, polyacrylonitrile block copolymers, proteins, and carbohydrates. In one embodiment, the thickener is hydrophilic fumed silica, preferably hydrophilic fumed silica particles. In another embodiment, the thickener is an attapulgite clay.

The skilled person is aware that thickening effects of thickeners depend on the physicochemical nature of a given liquid composition as compared to the molecular structure of a thickener. If the thickener predominantly contains polar functional groups, such as OH, COOH or SO₃H, the skilled person understands that such a thickener is predominantly applicable in polar, preferably protic solvents. Most prominently, xanthan gum and other non-modified polysaccharides are only able to unfold their full thickening of a liquid composition, if water or other protic solvents are added to the composition. On the other hand, if the thickener contains substantial hydrophobic moieties, it may be suitable for increasing the viscosity of non-polar solvents, such as in the case of dibutyl-lauroyl-glutamide. The skilled person is capable to identify thickeners that increase the viscosity of any given liquid composition by comparing the molecular structure of the thickener with the physico-chemical properties of the liquid composition.

On a functional level, the term “thickener” as used herein refers to a compound that increases the dynamic viscosity of a liquid composition if added, as compared to the same liquid composition without the compound.

A thickener may be defined as a compound that increases the dynamic viscosity of water of at least 0.1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 0.5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 10 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 25 mPas at 25° C. and at a shear rate of 100/second, if the thickener is added at to the water at a concentration of 1 wt %, wherein the water has a standard water hardness according to CIPAC of 342 ppm and a pH of 6.0-7.0.

In one embodiment, the thickener increases the dynamic viscosity of water of at least 50 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 100 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 250 mPas at 25° C. and at a shear rate of 100/second, if the thickener is added at to the water at a concentration of 1 wt %, wherein the water has a standard water hardness according to CIPAC of 342 ppm and a pH of 6.0-7.0.

The thickener is typically present in dissolved form in the agrochemical suspension. However, it may also be present in the form of particles. The agrochemical suspension typically comprises the thickener in a concentration of at least 0.1 wt %, preferably at least 0.5 wt % based on the total weight of the agrochemical suspension. The agrochemical suspension may comprise the thickener in a concentration of up to 5 wt %, preferably up to 2 wt % based on the total weigh of the agrochemical suspension.

The agrochemical suspension also contains naphthalenesulfonate formaldehyde condensate. These condensates are obtained by a condensation reaction of naphthalenesulfonate and formaldehyde. Such compounds are alternatively often referred to as alkylnaphthalenesulfonate condensate. Such compounds are commercially available under the trade name Morwet D425 from AkzoNobel. As described in Ullmann's Encyclopedia of Industrial Chemistry, 7^{th} Edition, Wiley-VCH Verlag, ISBN 9783527306732, Chapter Naphthalene Derivatives, the condensation reaction of formaldehyde with naphthalenesulfonate yields both the dimer of naphthalenesulfonate according to formula (I) and the polymer according to formula (II) as depicted in Schemes 1 and 2:

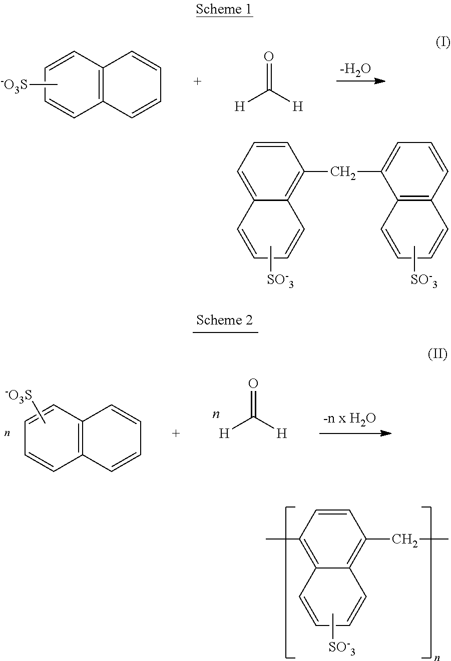

wherein the index n indicates the number of repeating units in the oligomeric or polymeric condensation product. Typically, the index n ranges from 2 to 1000,000, preferably from 2 to 1,000, such as from 2 to 100.

Accordingly, it will be appreciated that the term naphthalenesulfonate formaldehyde condensate may refer to a mixture to compounds of formula (I) and formula (II) in a wide range of ratios, e.g. a range of weight ratio of compounds of formula (I) to compounds of formula (II) of from 10,000:1 to 1:10,000, preferably from 100:1 to 1:100, more preferably from 10:1 to 1:10. In one embodiment the term “naphthalenesulfonate formaldehyde condensate” refers to compounds of formula (I). In another embodiment, the term “naphthalenesulfonate formaldehyde condensate” refers to compounds of formula (II).

The agrochemical suspension contains the naphthalenesulfonate formaldehyde condensate in a concentration of from 0.2 to 0.9 wt %, preferably from 0.4 to 0.6 wt % based on the total weight of the agrochemical suspension. The agrochemical suspension may contain the naphthalenesulfonate formaldehyde condensate in a concentration of at least 0.3, preferably at least 0.5 wt % based on the total weight of the agrochemical suspension. The agrochemical suspension may contain the naphthalenesulfonate formaldehyde condensate in a concentration of up to 0.8 wt %, preferably up to 0.7 wt % based on the total weight of the agrochemical suspension. The naphthalenesulfonate formaldehyde condensate is typically present in dissolved form in the agrochemical suspension.

The weight ratio of the naphthalenesulfonate formaldehyde condensate to the agrochemical active may vary in broad ranges. In one embodiment, the weight ratio of the naphthalenesulfonate formaldehyde condensate to the agrochemical active may be from 1:100 to 1:10,000, preferably from 1:500 to 1:5000.

The agrochemical suspension may optionally contain a non-ionic alkylpolyglucoside, such as a C₃-C₁₆-alkyl polyglycosides, preferably C₃-C₁₂-alkyl polyglycosides. Such compounds are commercially available under the trade names Agnique PG 9116, Agnique PG 8105, Agnique PG 8017, and Agnique PG 264. Suitable alkylpolyglycosides typically have an HLB-value of 11 to 15, preferably from 11 to 14, and display a degree of polymerization of from 1.1 to 2, preferably from 1.3 to 1.7. They may be based on various types of sugars, preferably on glucose.

The agrochemical suspension may contain the alkylpolyglycoside at a concentration of from 0.5 to 15 wt %, preferably from 1 to 10 wt % based on the total weight of the agrochemical suspension. The agrochemical suspension may contain the Alkylpolyglucoside in a concentration of at least 1.5 wt % based on the total weight of the agrochemical suspension. The agrochemical suspension may contain the alkylpolyglycoside in a concentration of up to 8 wt %, preferably up to 6 wt %, more preferably up to 4 wt %, most preferably up to 3 based on the total weight of the agrochemical composition.

The agrochemical suspensions may be produced as a broad variety of agrochemical formulations, e.g. SC, OD, or FS formulations. These and further compositions types are defined in the “Catalogue of pesticide formulation types and international coding system”, Technical Monograph No. 2, 6^{th} Ed. May 2008, CropLife International. The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Typically, the method comprises the step of contacting the thickener, the polymer P, the agrochemical active, and the naphthalenesulfonate formaldehyde condensate in any given order. Typically, the method also includes the step of milling or grinding the agrochemical active to the desired particle size.

The agrochemical suspension may contain a wide variety of auxiliaries. Suitable auxiliaries are solvents, liquid carriers, solid carriers or fillers, surfactants, dispersants, emulsifiers, wetters (also referred as wetting agents), adjuvants, solubilizers, penetration enhancers, protective colloids, adhesion agents, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted-fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

Solutions for seed treatment (LS), Suspoemulsions (SE), and flowable concentrates (FS), are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-touse preparations. Application can be carried out before or during sowing. Methods for applying the agrochemical suspension, respectively, on to plant propagation material, especially seeds include dressing, coating, pelleting, dusting, soaking and in-furrow application methods of the propagation material. Preferably, the agrochemical suspension is applied on to the plant propagation material by a method such that germination is not induced, e. g. by seed dressing, pelleting, coating and dusting.

The invention also relates to a tank mix containing the agrochemical suspension and an inorganic fertilizer.

Inorganic fertilizers are referred to herein using the fertilizer grade. All fertilizer labels comprise three numbers. The first number is the amount of nitrogen (N), the second number is the amount of phosphate (P2O5) and the third number is the amount of potash (K₂O). These three numbers represent the primary nutrients (nitrogen (N)-phosphorus (P)-potassium (K)). A 10-10-10 fertilizer contains 10 percent nitrogen, 10 percent phosphate and 10 percent potash.

Inorganic fertilizers are usually manufactured through chemical processes (such as the Haber process), also using naturally occurring deposits, while chemically altering them (e.g. concentrated triple superphosphate). Naturally occurring inorganic fertilizers include Chilean sodium nitrate, mine rock phosphate, limestone, and raw potash fertilizers. The inorganic fertilizer may, in a specific embodiment, be a NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca and trace elements.

Other inorganic fertilizers include ammonium nitrate, calcium ammonium nitrate, ammonium sulfate nitrate, ammonium sulfate or ammonium phosphate.

Urea-containing fertilizer may, in specific embodiments, be urea, formaldehyde urea, urea ammonium nitrate (UAN) solution, urea sulfur, stabilized urea, urea based NPK-fertilizers, or urea ammonium sulfate. In case urea-containing fertilizers or urea are used or provided, it is particularly preferred that urease inhibitors as defined herein above may be added or additionally be present or be used at the same time or in connection with the urea-containing fertilizers. Urea-containing fertilizers are hydrolyzed by microorganisms, thereby releasing ammonia that in turn forms ammonium-ions. Urea-containing fertilizers may thus be considered as a storage form of ammonium.

Preferably, the fertilizer may be a solid or liquid ammonium-containing inorganic fertilizer such as an NPK fertilizer (which provides nitrogen, phosphorus, and potassium), ammonium nitrate, calcium ammonium nitrate, ammonium sulfate nitrate, ammonium sulfate or ammonium phosphate; or an urea-containing fertilizer such as urea, formaldehyde urea, urea ammonium nitrate (UAN) solution, urea sulfur, stabilized urea, urea based NPK-fertilizers, urea ammonium sulfate, or a mixture thereof. Most preferably, the fertilizer is an NPK fertilizer, especially a fertilizer containing nitrogen and phosphorous in any inorganic form, but no potassium. In one embodiment, the inorganic fertilizer comprises ammonium phosphate and/or ammonium polyphosphate.

The tank mix may comprise the fertilizer at a concentration of from 1 to 99.9 wt %, preferably of from 5 to 99 wt %, more preferably of from 5 to 95 wt %, most preferably of from 20 to 80 wt % based on the total weight of the tank mix. The tank mix may comprise at least 30 wt % of the fertilizer, preferably at least 50 wt %, more preferably at least 90 wt % of the fertilizer based on the total weigh of the tank mix. The tank mix typically comprises up to 99.9 wt % of the fertilizer based on the total weight of the tank mix, preferably up to 95 wt %, more preferably up to 90 wt %.

The tank mix comprises the agrochemical suspension at a concentration of from 1 to 99.9 wt %, preferably of from 5 to 99 wt %, more preferably of from 5 to 95 wt %, most preferably of from 20 to 80 wt % based on the total weight of the tank mix. The tank mix may comprise at least 30 wt % of the agrochemical suspension, preferably at least 50 wt %, more preferably at least 90 wt % of the agrochemical suspension based on the total weigh of the tank mix. The tank mix typically comprises up to 99.9 wt % of the agrochemical suspension based on the total weight of the tank mix, preferably up to 95 wt %, more preferably up to 90 wt %.

The weight ratio of the agrochemical suspension to the inorganic fertilizer in the tank mix may vary in broad ranges, such as from 100:1 to 1:100, preferably from 98:2 to 2:98, most preferably from 95:1 to 1:95.

The tank mix may be prepared by contacting the agrochemical suspension, and the inorganic fertilizer, and optionally water in any suitable order. The contacting is typically achieved by mixing the components in a tank.

The tank mix may further contain auxiliaries as specified above for the agrochemical suspension. Typically, the tank mix may also contain further agrochemical actives, especially nitrification and/or urease inhibitors as specified above.

The invention further relates to a method of controlling phytopathogenic fungi and/or undesired plant growth and/or undesired insect or mite attack and/or for regulating the growth of plants, wherein the agrochemical suspension or the tank mix is allowed to act on the respective pests, their environment or the crop plants to be protected from the respective pest, on the soil and/or on undesired plants and/or on the crop plants and/or on their environment.

When employed in plant protection, the amounts of agrochemical active applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials such as seeds, e. g. by dusting, coating or drenching seed, amounts of agrochemical active of from 0.1 to 1000 g, preferably from 1 to 1000 g, more preferably from 1 to 100 g and most preferably from 5 to 100 g, per 100 kilogram of plant propagation material (preferably seeds) are generally required.

When used in the protection of materials or stored products, the amount of agrochemical active applied depends on the kind of application area and on the desired effect. Amounts customarily applied in the protection of materials are 0.001 g to 2 kg, preferably 0.005 g to 1 kg, of active substance per cubic meter of treated material.

The user applies the agrochemical suspension or the tank mix according to the invention usually from a pre-dosage device, a knapsack sprayer, a drone, a spray tank, a spray plane, or an irrigation system. Usually, the agrochemical suspension is made up with water, buffer, and/or further auxiliaries to the desired application concentration and the ready-to-use spray liquor or the agrochemical suspension according to the invention is thus obtained. Usually, 20 to 2000 liters, preferably 50 to 400 liters, of the ready-to-use spray liquor are applied per hectare of agricultural useful area.

According to one embodiment, individual components of the agrochemical suspension or the tank mix according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components may be mixed by the user in a spray tank and further auxiliaries and additives may be added, if appropriate.

In a further embodiment, either individual components of the composition according to the invention or partially premixed components can be applied jointly (e.g. after tank mix) or consecutively.

Advantages of the present invention are, inter alia, that it makes a high storage stability of the formulation possible, even at elevated temperatures or under alternating temperatures, and moreover in the presence of high salt concentrations; that the particle size growth of dispersed agrochemical active substances is slowed down or suppressed; that the agglomeration of dispersed agrochemical particles is slowed down or suppressed; that the settling of dispersed agrochemical active substances is slowed down or suppressed; and that the abovementioned advantages are also attained in the presence of high salt concentrations.

The examples which follow illustrate the invention without imposing any limitation.

### EXAMPLES

Materials Used:
Pesticide: compound of formula (I-A)
Polymer P: homopolymer of acrylic acid, 2-mercaptoethanol terminated, molecular weight 250,000 Da, water content 65 wt %, viscosity at 23° C. according to Brookfield at 60 rpm is approximately 5000 mPas.
Auxiliary 1: C₉-C₁₁-alkyl polyglycoside, yellow liquid, boiling point>93° C., 50% solution in water
Auxiliary 2: emulsion of polydimethylsiloxane on silica particles.
Auxiliary 3: a low viscosity, water based dispersion of hydrophilic fumed silica with a slightly alkaline pH, solid content 22 wt %
Stabilizer 1: alkylnaphthalenesulfonate condensate, sodium salt
Stabilizer 2: nonionic high HLB polyalkylene oxide block copolymer
Stabilizer 3: ethoxylated castor oil
Stabilizer 4: nonionic butyl based block copolymer; HLB=12
Stabilizer 5: highly sulfonated lignosulfonate
Stabilizer 6: nonionic acrylic copolymer solution; HLB=12
Stabilizer 7: Lignosulfonate
Stabilizer 8: nonionic proprietary surfactant blend; HLB=16
Stabilizer 9: alcohol ethoxylate
Stabilizer 10: nonionic difunctional block copolymer surfactant terminating in primary hydroxyl groups
Stabilizer 11: tristyrylphenol ethoxylate; EO=10
Stabilizer 12: anionic tristyrylphenol phosphate
Stabilizer 13: nonionic difunctional block copolymer surfactant terminating in primary hydroxyl groups
Stabilizer 14: anionic tristyrylphenol phosphate
Stabilizer 15: ethoxylated phosphate ester
Stabilizer 16: anionic sodium methyl oleoyl taurate
10-34-0 fertilizer: liquid fertilizer composition containing 10 wt % total nitrogen (N), 35 wt % of available phosphor (P2O5) in water.

### Example-1: Screening of Stabilizers

Agrochemical suspensions SC1 to SC17 were prepared with the ingredients as specified in Table A, wherein different stabilizers were added to the suspensions according to Table B. The suspensions were prepared by mixing water and well dispersed Auxiliary 3 together. Then the propylene glycol, biocide, and Auxiliary 2 were added to the composition, which was subsequently mixed until uniform. Next Polymer P and Auxiliary 1 were mixed to the composition. Finally, the Pesticide was added to the mixture, which was subsequently mixed until uniform. The resulting composition was then milled in a bead mill until a mean particle size of 2-3 microns was obtained, upon which, it was mixed with the Stabilizer of choice according to Table B until homogenous.

The suspensions were then checked for initial formulation physical stability, compatibility with 10-34-0 fertilizer after 24 hours, and physical stability after 2 weeks in the −10° C./30° C. cycling chamber and in a 54° C. oven. Fertilizer compatibility testing was done at mixing ratio of 95:5 (wt/wt) of the 10-31-0 liquid fertilizer to the agrochemical suspension. Mixing was effected in a glass tube. After mixing, the glass tube was kept on the lab bench for 24 hours at 20° C., visual observation of mixture phase separation was performed as an indicator of degree of fertilizer compatibility. The testing results are summarized in Table B.

TABLE A
Ingredients of SC1 to SC17, wherein the Stabilizer
was varied according to Table B

| Ingredient | Concentration (wt %) |
|---|---|
| Pesticide | 41.08 |
| Polymer P | 4.36 |
| Auxiliary 1 | 3.39 |
| Stabilizer | 0.48 |
| Auxiliary 2 | 0.49 |
| Biocide | 0.27 |
| Propylene glycol | 9.70 |
| Auxiliary 3 | 3.53 |
| Water | to 100% |

TABLE B
screened Stabilizers in suspensions SC1 to SC17; initial stability assessment,
after temperature cycling, and after addition of fertilizer 10-34-0.

| | | Initial | | Flowability | |
|---|---|---|---|---|---|
| | | formulation | Compatible with | after 2 weeks | Flowability |
| Suspension | | physical | 10-34-0 fertilizer | cycling from −10° | after 2 weeks |
| number | Stabilizer | stability | after 24 hours? | C. to 30° C. | at 54° C. |
| SC1 | None | Flows | Yes | Almost gelled | Gelled |
| SC2 | Stabilizer 1 | Flows | Yes | Flowable | Flowable |
| SC3 | Stabilizer 2 | Gells | N/A | N/A | N/A |
| SC4 | Stabilizer 3 | Gells | N/A | N/A | N/A |
| SC5 | Stabilizer 4 | Gells | N/A | N/A | N/A |
| SC6 | Stabilizer 5 | Flows | Yes | Flowable | Semi- |
| | | | | | flowable |
| SC7 | Stabilizer 6 | Gells | N/A | N/A | N/A |
| SC8 | Stabilizer 7 | Flows | Yes | Semi Flowable | Gelled |
| SC9 | Stabilizer 8 | Gells | N/A | N/A | N/A |
| SC10 | Stabilizer 9 | Gells | N/A | N/A | N/A |
| SC11 | Stabilizer 10 | Gells | N/A | N/A | N/A |
| SC12 | Stabilizer 11 | Gells | N/A | N/A | N/A |
| SC13 | Stabilizer 12 | Gells | N/A | N/A | N/A |
| SC14 | Stabilizer 13 | Gells | N/A | N/A | N/A |
| SC15 | Stabilizer 14 | Gells | N/A | N/A | N/A |
| SC16 | Stabilizer 15 | Flows | Very little | Gelled | Gelled |
| | | | agglomeration | | |
| | | | but overall | | |
| | | | compatible | | |
| SC17 | Stabilizer 16 | Flows | Yes | Gelled | Gelled |

The results of Table B demonstrate that only Stabilizer 1 was capable of stabilizing the formulation both upon addition of fertilizer and temperature cycling or elevated temperatures.

### Example-2: Screening of Concentrations

Agrochemical suspensions SC18 to SC21 were prepared with the ingredients as specified in Table C, wherein different concentrations of Stabilizer 1 were added to the suspensions according to Table D. The suspensions were prepared by mixing water and well dispersed Auxiliary 3 together. Then the propylene glycol, biocide, and Auxiliary 2 were added to the composition, which was subsequently mixed until uniform. Next Polymer P, Auxiliary 1, and Stabilizer 1 were mixed to the composition. Finally, the Pesticide was added to the mixture, which was subsequently mixed until uniform. The resulting composition was then milled in a bead mill until a mean particle size of 2-3 microns was obtained. The suspensions were then analyzed on their formulation stability as described in Example 1. The results were summarized in Table 0.

TABLE C
Ingredients of SC18 to SC21, wherein the concentration
of Stabilizer 1 was varied according to Table B

| Ingredient | Concentration (wt %) |
|---|---|
| Pesticide | 42.37 |
| Polymer P | 4.50 |
| Auxiliary 1 | 4.00 |
| Stabilizer 1 | See Table D |
| Auxiliary 2 | 0.51 |
| Biocide | 0.27 |
| Propylene glycol | 10.00 |
| Auxiliary 3 | 3.64 |
| Water | to 100 |

TABLE D
screened concentrations of Stabilizer 1 in suspensions SC18 to SC21; initial stability
assessment, after temperature cycling, and after addition of fertilizer 10-34-0.

| | | Initial | | Flowability | |
|---|---|---|---|---|---|
| | | formulation | Compatible with | after 2 weeks | Flowability |
| Suspension | Concentration | physical | 10-34-0 fertilizer | cycling from −10° | after 2 |
| number | of Stabilizer 1 | stability | after 24 hours? | C. to 30° C. | weeks at 54° C. |
| 18 | 0.00% | Flows | Yes | Gelled | Gelled |
| 19 | 0.10% | Flows | Yes | Gelled | Gelled |
| 20 | 0.55% | Flows | Yes | Flowable | Flowable |
| 21 | 1.00% | Flows | No | Flowable | Flowable |

1. An agrochemical suspension comprising
a) an agrochemical active, wherein the agrochemical active is present in a form of suspended particles in the agrochemical suspension.
b) a polymer P being a homo- or copolymer of (meth)acrylic acid with a mass average molar mass M_{w} of at least 100,000 Da;
c) a thickener; and
d) naphthalenesulfonate formaldehyde condensate,
wherein a concentration of the naphthalenesulfonate formaldehyde condensate is from 0.2 to 0.9 wt % based on a total weight of the suspension.

2. The agrochemical suspension according to claim 1, wherein the polymer P is a (meth)acrylic acid homopolymer.

3. The agrochemical suspension according to claim 1, wherein the polymer P is end-capped with 2-mercaptoethanol.

4. The agrochemical suspension according to claim 1, wherein a concentration of the polymer P is from 0.1 to 5 wt % based on the total weight of the suspension.

5. The agrochemical suspension according to claim 1, wherein the thickener is a hydrophilic fumed silica thickener.

6. The agrochemical suspension according to claim 1 containing a non-ionic alkyl polyglycoside.

7. The agrochemical suspension according to claim 6, wherein a concentration of the polyglycoside is from 1 to 10 wt % based on the total weight of the suspension.

8. The agrochemical suspension according to claim 1, wherein a concentration of the naphthalenesulfonate formaldehyde condensate is from 0.4 to 0.6 wt % based on the total weight of the suspension.

9. The agrochemical suspension according to claim 1, wherein the agrochemical active has a water-solubility at 20° C. and pH 7 of up to 1 g/l.

10. The agrochemical suspension according to claim 1, wherein the suspension is an aqueous suspension containing at least 20 wt % of water based on the total weight of the suspension.

11. A tank mix comprising the agrochemical suspension according to claim 1 and an inorganic fertilizer.

12. The tank mix according to claim 11, wherein the inorganic fertilizer comprises ammonium phosphate and/or ammonium polyphosphate.

13. A method for preparing a tank mix comprising contacting an inorganic fertilizer with the agrochemical suspension as defined in claim 1.

14. A method of controlling phytopathogenic fungi and/or undesired plant growth and/or undesired insect or mite attack and/or for regulating the growth of plants, wherein the agrochemical suspension as defined in claim 1 contacts respective pests, their environment or the crop plants to be protected from the respective pest, on the soil and/or on undesired plants and/or on the crop plants and/or on their environment.
